(19) United States
(12) Patent Application Publication
(10) Pub. No.: US 2016/0292753 A1
(43) Pub. Date: Oct. 6, 2016

(54) Systems and Methods for Generating Donations From Payment Account Transactions

(71) Applicant: MASTERCARD INTERNATIONAL INCORPORATED, Purchase, NY (US)

(72) Inventors: Mary Fuller, Brussels (BE); Michael Rethorn, Wildwood, MO (US); Amy King, St. Louis, MO (US); Jerry Davis, Wildwood, MO (US); James Hostetler, St. Charles, MO (US); Gregory Scott Kriebaum, St. Peters, MO (US)

(21) Appl. No.: 14/672,552

(22) Filed: Mar. 30, 2015

(51) Int. Cl. G06Q 30/02; G06Q 20/22; G06Q 20/10

(52) U.S. Cl. CPC G06Q 30/0279; G06Q 20/10; G06Q 20/29

(57) ABSTRACT

Exemplary systems and methods for generating donations to charities based on transactions to payment accounts are disclosed. One exemplary method includes identifying at least one transaction associated with a payment account; generating, by a computing device, a donation value to the payment account based on the at least one transaction; aggregating, by the computing device, the donation value for the at least one transaction; and submitting a donation transaction, to an acquirer associated with the charity, for payment to the charity of an amount based on at least the aggregated donation values.

### FIELD

The present disclosure generally relates to systems and methods for generating donations to, for example, one or more charities, etc. based on transactions by consumers to payment accounts associated with the consumers.

### BACKGROUND

This section provides background information related to the present disclosure which is not necessarily prior art.

Donations to charities are known. The donations are often provided by donors to the charities in the form of cash, checks, payment account transactions, etc. In addition, the donations may be provided by the donors, to the charities, as one-time donations or as repeat donations, or even as scheduled donations, depending on the donors.

### DRAWINGS

The drawings described herein are for illustrative purposes only of selected embodiments and not all possible implementations, and are not intended to limit the scope of the present disclosure.

FIG. 1 is a block diagram of an exemplary system of the present disclosure suitable for use in generating donations to charities, from consumers, based on payment account transactions by the consumers;

FIG. 2 is a block diagram of a computing device that may be used in the exemplary system of FIG. 1;

FIG. 3 is an exemplary interface for use by a consumer to register a payment account to have donations generated, on behalf of the consumer, based on transactions by the consumer to the payment account; and

FIG. 4 is an exemplary method for generating donations to a charity based on transactions, by a consumer, to a payment account associated with the consumer.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Charities often encourage consumers (broadly, donors herein) to make regular donations. In connection with the donations, the consumers may be permitted to create automatic debits or other transactions for set amounts at regular intervals, for example, weekly intervals, etc., to the charities. The systems and methods herein, in particular, permit the consumers to tie (or link) the donations to the charities to transactions involving payment accounts associated with the consumers, subject to various conditions, whereby the donations are automatically made to the charities, and are also based on particular activities of the consumers.

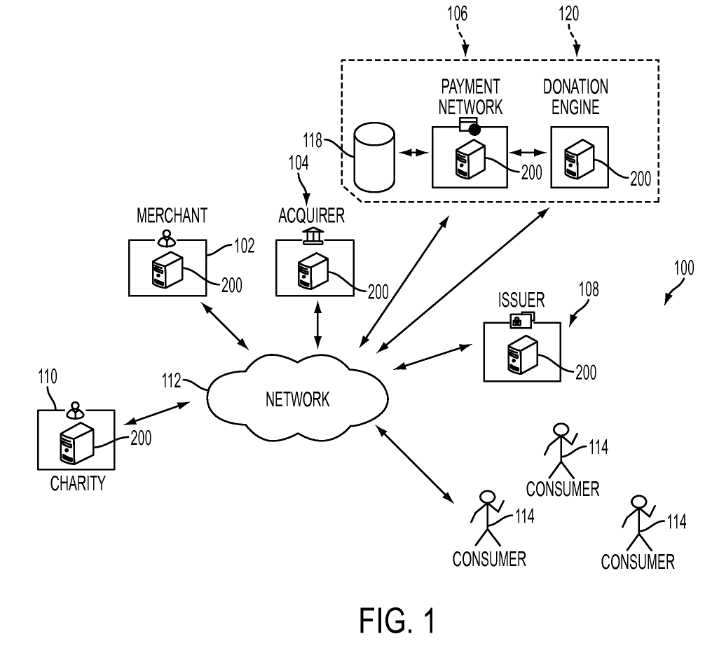

FIG. 1 illustrates an exemplary system 100, in which the one or more aspects of the present disclosure may be implemented. Although, in the described embodiment, components of the system 100 are presented in one arrangement, other embodiments may include the same or different components arranged otherwise, depending, for example, on authorization processes for payment device transactions, etc.

As shown in FIG. 1, the system 100 generally includes a merchant 102, an acquirer 104, a payment network 106, an issuer 108, and a charity 110, each coupled to network 112. The network 112 may include, without limitation, a local area network (LAN), a wide area network (WAN) (e.g., the Internet, etc.), a mobile network, a virtual network, and/or another suitable public and/or private network capable of supporting communication among two or more of the components illustrated in FIG. 1, or any combinations thereof. For example, network 112 may include multiple different networks, such as a transaction network accessible by the payment network 106 and/or the Internet.

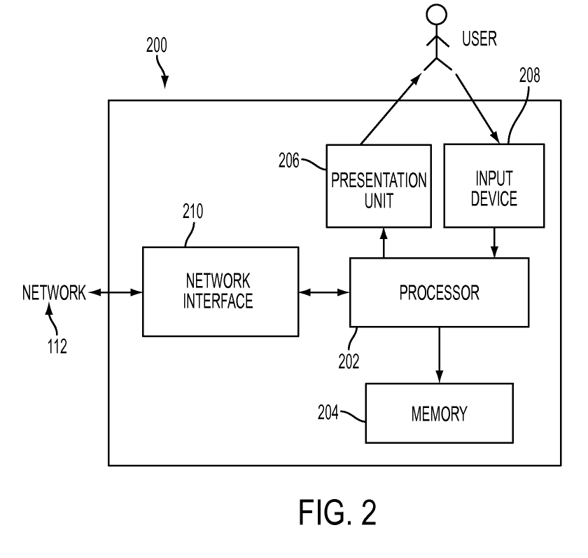

Each of the merchant 102, the acquirer 104, the payment network 106, the issuer 108, and the charity 110 of the system 100 may be implemented in, or associated with, one or more computing devices. For illustration, the system 100 is described with reference to exemplary computing device 200, illustrated in FIG. 2. For example, each of the merchant 102, the acquirer 104, the payment network 106, the issuer 108, and the charity 110 of the system 100 are associated with a computing device 200. However, the system 100 and its components should not be considered to be limited to the computing device 200, as different computing devices and/or arrangements of computing devices may be used. In addition, different components and/or arrangements of components may be used in other computing devices. Further, in various exemplary embodiments, the computing device 200 may include multiple computing devices located in close proximity, or distributed over a geographic region. Additionally, each computing device 200 may be coupled to a network (e.g., the Internet, an intranet, a private or public LAN, WAN, mobile network, telecommunication networks, combinations thereof, or other suitable network, etc.) that is either part of the network 112, or separate therefrom.

By way of example, the exemplary computing device 200 may include one or more servers, personal computers, laptops, tablets, PDAs, telephones (e.g., cellular phones, smartphones, other phones, etc.), point of sale (POS) terminals, combinations thereof, etc. as appropriate.

With reference to FIG. 2, the illustrated computing device 200 includes a processor 202 and a memory 204 that is coupled to the processor 202. The processor 202 may include, without limitation, one or more processing units (e.g., in a multi-core configuration, etc.), including a general purpose central processing unit (CPU), a microcontroller, a reduced instruction set computer (RISC) processor, an application specific integrated circuit (ASIC), a programmable logic circuit (PLC), a gate array, and/or any other circuit or processor capable of the functions described herein. The above examples are exemplary only, and thus are not intended to limit in any way the definition and/or meaning of processor.

The memory 204, as described herein, is one or more devices that enable information, such as executable instructions and/or other data, to be stored and retrieved. The memory 204 may include one or more computer-readable media, such as, without limitation, dynamic random access memory (DRAM), static random access memory (SRAM), read only memory (ROM), erasable programmable read only memory (EPROM), solid state devices, flash drives, CD-ROMs, thumb drives, tapes, flash drives, hard disks, and/or any other type of volatile or nonvolatile physical or tangible computer-readable media. The memory 204 may be configured to store, without limitation, user preferences, conditions, consumer registrations, charity merchant identifiers, transaction data, and/or other types of data suitable for use as described herein, etc.

Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer-readable media. It should be appreciated that the memory 204 may include a variety of different memories, each implemented in one or more of the functions or processes described herein.

In the exemplary embodiment, the computing device 200 includes a presentation unit 206 that is coupled to the processor 202. The presentation unit 206 outputs, or presents, to a user (e.g., consumers 114 in system 100, individuals associated with the charity 110 in system 100, etc.) by, for example, displaying, audibilizing, and/or otherwise outputting information such as, but not limited to, consumer data, transaction data, merchant data, product and/or service data, charity data, and/or any other type of data. It should be further appreciated that, in some embodiments, the presentation unit 206 comprises a display device such that various interfaces (e.g., applications, webpages, etc.) may be displayed at computing device 200, and in particular at the display device, to display such information and data, etc. And in some examples, the computing device 200 may cause the interfaces to be displayed at a display device of another computing device, including, for example, a server hosting a website having multiple webpages, etc. Presentation unit 206 may include, without limitation, a liquid crystal display (LCD), a light-emitting diode (LED) display, an organic LED (OLED) display, an “electronic ink” display, speakers, combinations thereof, etc. In some embodiments, presentation unit 206 includes multiple units.

The computing device 200 also includes an input device 208 that receives input from the user. The input device 208 is coupled to the processor 202 and may include, for example, a keyboard, a pointing device, a mouse, a stylus, a touch sensitive panel (e.g., a touch pad or a touch screen, etc.), another computing device, and/or an audio input device. Further, in some exemplary embodiments, a touch screen, such as that included in a tablet, a smartphone, or similar device, behaves as both presentation unit 206 and input device 208. In at least on exemplary embodiment, the presentation unit and input device are omitted.

In addition, the illustrated computing device 200 includes a network interface 210 coupled to the processor 202 (and, in some embodiments, to the memory 204 as well). The network interface 210 may include, without limitation, a wired network adapter, a wireless network adapter, a mobile telecommunications adapter, or other device capable of communicating to one or more different networks, including the network 112. In some exemplary embodiments, the computing device 200 includes the processor 202 and one or more network interfaces incorporated into or with the processor 202.

Referring again to FIG. 1, typically in the illustrated system 100, the merchant 102, the acquirer 104, the payment network 106, and the issuer 108 cooperate, in response to a request from a consumer 114, to complete a payment transaction for a product and/or service using a payment account. As part of the payment transaction, the consumer 114 initially provides information about the payment account to the merchant 102 (e.g., a payment account number, etc. via a payment card, other payment device (e.g., a fob, a smartphone, etc.), or via login credentials for a previously established purchase account (e.g., an electronic wallet such as MasterPass™, Google Wallet, PayPass, Softcard®, etc.), etc.). The merchant 102 reads the payment account information and communicates, via the network 112, an authorization request to the payment network 106, via the acquirer 104 (associated with the merchant 102), to process the transaction (e.g., using the MasterCard® interchange, etc.). The authorization request includes various details of the transaction (e.g., transaction data, etc.) to help facilitate processing the authorization request. The payment network 106, in turn, communicates the authorization request to the issuer 108 (associated with the consumer's payment account). The issuer 108 then provides an authorization response (e.g., authorizing or declining the request) to the payment network 106, which is provided back through the acquirer 104 to the merchant 102. The transaction with the consumer 114 is then completed by the merchant 102. Depending on the authorization response, the transaction is approved or denied.

Transaction data is generated as part of the above interactions among the merchant 102, the acquirer 104, the payment network 106, the issuer 108, and the consumer 114. Depending on the transaction, the transaction data is transmitted from the merchant 102 to the issuer 108 through the payment network 106 (e.g., as part of the authentication request, as part of a separate request, etc.). The transaction data may include, without limitation, a payment account number for the consumer's payment account, a payment amount for the transaction, identifier(s) for the product(s) and/or service(s) purchased in the transaction, description(s) of the product(s) and/or service(s) purchased in the transaction, a listing of product(s) and/or service(s) purchased in the transaction, a merchant name for the merchant 102, a merchant identification number (MID) for the merchant 102, a merchant category code (MCC) for the merchant 102, a date and/or time of the transaction, an amount of the transaction, etc.

Other payment transactions in the system 100, involving the consumer 114, the merchant 102, other ones of the consumers 114, other consumers accommodated by the system 100 but not shown, and other merchants accommodated by the system 100 but not shown, are also processed in a similar manner to the above payment transaction between the consumer 114 and the merchant 102. Transaction data is also generated in connection with these payment transactions.

Once generated, the transaction data may be stored in one or more different components of the system 100. In the illustrated embodiment, for example, the payment network 106 collects the transaction data and stores it in data structure 118. As such, the data structure 118 includes a compilation of consumers and merchants involved in the payment transactions processed by the payment network 106 and the corresponding transaction data for the payment transactions. For the above transaction between the consumer 114 and the merchant 102 (as well as for various other transactions in the system 100), the transaction data is stored in the data structure 118 according to one or more of the payment account associated with the consumer 114, the merchant 102 (e.g., the MID for the merchant 102, the MCC for the merchant 102, etc.), or any other criteria, such that the transaction data is readily usable as described herein. It should be appreciated that the same or different transaction data may be collected and stored within other components of the system 100. In addition, while the data structure 118 is illustrated separate from the payment network 106 in the system 100, it should be appreciated that the data structure 118 may be included in the memory 204 of the payment network computing device 200 in various implementations.

In various exemplary embodiments, consumers involved in the different transactions herein agree to legal terms associated with their payment accounts, for example, during enrollment in their accounts, etc. In so doing, the consumers may agree, for example, to allow merchants, issuers of the payment accounts, payment networks, etc. to use data collected during enrollment and/or collected in connection with processing the transactions, subsequently for one or more of the different purposes described herein.

With further reference to FIG. 1, the charity 110 includes any organization or group (or any multiple organizations or groups), to which the consumers 114 may donate funds. Without limitation, the charity 110 may be associated with a specific religion, various politics, one or more beneficiaries, or any other category of person or entity to which the consumers 114 may donate funds.

In the system 100, the charity 110 hosts a website (directly, or via a third party such as through the payment network 106 or other party, etc.) in order to disseminate information about the charity and/or register consumers 114 to make donations to the charity 110, as described herein. Additionally, or alternatively, an application may be made available by the charity 110 (directly, or through the third party such as the payment network 106 or other party, etc.), to the consumers 114 (e.g., through the website, through other means, etc.), which functions substantially consistent with the charity's website described herein.

In registering the consumers 114, the charity 110 and, in particular, the website associated with the charity 110, causes different interfaces to be displayed to the consumers 114 (e.g., at presentation units of computing devices associated with the consumers 114, etc.). As an example, in registering a consumer 114, an interface, displayed via the charity's website, may solicit from the consumer 114, without limitation, various information (e.g., demographic, etc.) about the consumer 114, contact information for the consumer 114, payment account information (e.g., account number, expiration date, security code, etc.) for the consumer 114, conditions and/or user preferences for donations for the consumer 114 (as described below), appropriate authorizations from the consumer 114, selections and/or approvals to enable/disable donations, etc. The consumer 114 may then set, through the interface, one or more of an amount to donate, a donation amount per transaction, a donation limit per interval, and a donation percentage per transaction. Other criteria (e.g., other qualifying criteria, base level criteria that excludes certain activity for various reasons, etc.) may also (or alternatively) be included in the interface, such as (without limitation) types of transactions to qualify or not-qualify for donations (e.g., by transaction amount, by MCC, by transaction time/date, by transaction threshold, by whether the transaction involves commercial activity or not, by whether the transaction involves a charitable transaction or not, by lifecycle data (e.g., chargeback data, etc.), etc.), and/or other conditions related to amount, frequency, timing, etc., of the consumer's donations. These criteria will typically be determined by the payment network 106. However, it should be appreciated that in some embodiments, the criteria (or others) may be set and/or modified by the consumer 114 (e.g., through the interface, etc.) as well (or alternatively).

In addition, in registering at the charity 110 (or at a different time), the consumers 114 may also set preferences regarding reporting of the consumer's donations, to the consumers 114 or to one or more third parties, and of terms and conditions of the registration. In various embodiments, the charity's website (or application) further permits the consumers 114 to select particular parts/goals of the charity 110 to which donations should be directed, or even different charities to which the consumers' donations will be earmarked. The website (or application) may also require the consumers 114 to login, before registering or before making changes to any information or conditions supplied during the registration. For example, in the system 100, a login is required before a consumer 114 is allowed to disable any donations, either indefinitely (i.e., end donations) or for a specified period of time (i.e., suspend donations).

While, in the foregoing description, the charity 110 is described as registering the consumers 114, it should be appreciated that the payment network 106, or other entity, may also (or alternatively) register the consumers 114. This may be done in concert with the charity 110, or it may be done independent from the charity 110 (but still on behalf of the charity).

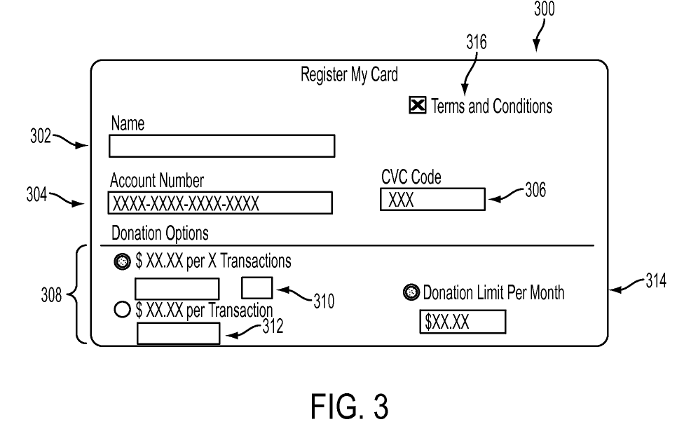

FIG. 3 illustrates an example interface 300 that may be made available to a consumer 114 in the system 100, through a website (or application), by the charity 110 or another entity (e.g., in connection with registering the consumer 114, etc.). As shown, upon presentation to the consumer 114, the interface 300 solicits a name 302 of the consumer 114, an account number 304 for a payment account associated with the consumer 114 and to be used in connection with making donations to the charity 110, a CVC code 306 (or other security code) from a payment device associated with the consumer's payment account, and various donation conditions 308. In the interface 300, the payment conditions 308 include two general options: an indication 310 of a desired donation amount to be made by the consumer 114 for a particular desired number of transactions, and in indication 312 of a desired donation amount to be made by the consumer 114 per transaction (regardless of the number of transactions). The payment conditions 308, in the interface 300, then also permit the consumer 114 to enter an indication 314, if desired, for a donation limit (or maximum donation) to be made each month (or other time period) by the consumer 114. Further, the interface 300 includes an indicator 316 to be selected by the consumer 114 providing consent/approval to any terms and conditions of the registration.

Referring again to FIG. 1, the charity 110 may manage the registration of the consumers 114, and their payment accounts, without interaction with the payment network 106. Alternatively, the charity's website may communicate with the payment network 106, or part thereof, via an application program interface (API), whereby the information provided by the consumers 114 during registration is provided to the payment network 106. Or, the payment network 106 (or another entity) may manage the registration of the consumers 114, and then communicate the registration with the charity 110.

Regardless of how the consumers 114 are registered, information about the consumers 114 and their payment accounts is provided, for example, by the charity 110 (e.g., by the computing device 200 associated with the charity 110, etc.), by the payment network 106 (e.g., by the computing device 200 associated with the payment network 106, etc.) to a donation engine 120. In the illustrated system 100, the donation engine 120 is associated with computing device 200, and is incorporated into the payment network 106 (as indicated by the broken lines in FIG. 1). However, it should be appreciated that, in other embodiments, the donation engine 120 may be a separate entity in the system 100 (and may communicate with the charity 110 and/or the payment network 106 via network 112), or the donation engine 120 may be incorporated into other entities shown in the system 100 (e.g., the issuer 108, etc.) or not shown in the system 100.

The donation engine 120 is configured, often by computer-readable instructions, to, among other functions described herein, generate donations to the charity 110 (or other charities) based, in part, on transactions by the consumers 114 to their registered payment accounts. In particular, for each of the consumers 114, the donation engine 120 identifies transactions to the consumer's payment account and generates donation indicators for the transactions based on one or more predefined conditions (e.g., based on one or more user preferences set by the corresponding consumer 114 during registration, based on criteria set by the payment network 106, combinations thereof, etc.). Next, the donation engine 120 aggregates the donation indicators, for a predefined interval (e.g., for a third-interval, for a one-month interval, for a two-week interval, etc.). The donation engine 120 then generates a transaction to the consumer's payment account in the form of a donation (broadly, a payment) to the charity 110, based on the aggregated donation indicators, and submits the transaction to the acquirer 104 (which is also associated with the charity 110 in the system 100). Generally, the donation engine 120 creates a batch file, which includes multiple donation-based transactions to the charity 110 for the predefined interval (e.g., from the multiple consumers 114, etc.), and submits the batch file to the acquirer 104. Once received, the transaction (or the multiple transactions in the batch file) is handled substantially consistent to the payment transaction described above between the consumer 114 and the merchant 102. Any declined transaction or other issues with a transaction are provided back to the payment network 106 (acting on behalf of the merchant 102) to allow for additional attempts, as desired, and to maintain consistent reporting, and/or back to the charity 110 and/or back to the donation engine 120, or are reported to the consumer 114, via an alert or through regular and/or periodic reporting.

It should be appreciated that the amount, timing, and/or other aspects of the donation-based transactions, generated by the donation engine 120, may be based on conditions set by the consumer 114, by the acquirer 104, by the charity 110, the payment network 106, and/or by the donation engine 120.

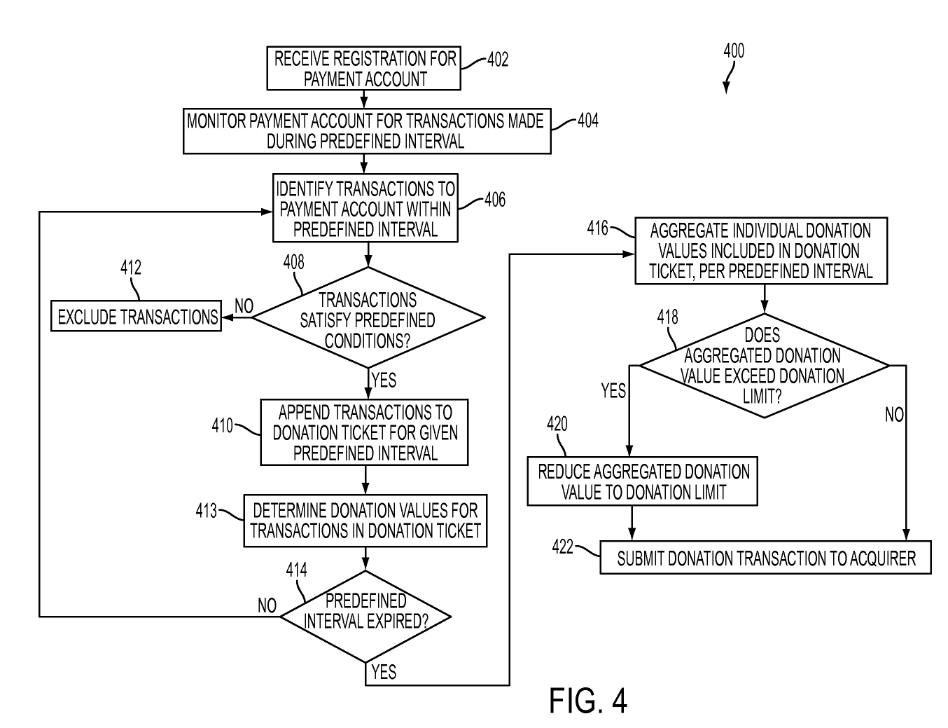

FIG. 4 illustrates an exemplary method 400 of generating donations, based on transactions by a consumer to a payment account associated with the consumer. The exemplary method 400 is described herein in connection with the system 100, and may be implemented in any one or more of the payment network 106 (e.g., the donation engine 120 associated with the payment network 106, etc.) and the issuer 108 of the system 100, each of which includes one or more computing devices, as described above. Further, for purposes of illustration, the exemplary method 400 is also described with reference to computing device 200. It should be appreciated that the method 400, or other methods described herein, are not limited to the system 100, or computing device 200. And, conversely, the systems and computing devices described herein are not limited to the exemplary method 400.

As shown in FIG. 4, in the method 400, the donation engine 120 receives, at 402, a registration for a consumer 114, and for a payment account associated with the consumer, for example, from the charity 110 or, in other embodiments, from various parts of the payment network 106 separate from the charity 110. The registration includes payment account information for the consumer 114, and user preferences and/or donation conditions selected or defined by the consumer 114 with regard to donations to be made on behalf of the consumer 114. In some embodiments, the donation engine 120 also validates the consumer's registration at this time by submitting a test transaction (or validation transaction) to the acquirer 104 for a nominal amount (e.g., $0, another nominal amount, etc.). The test transaction permits the donation engine 120 to confirm the accuracy of the information provided by the consumer 114 during registration (e.g., the payment account information, etc.), and to confirm formatting, etc. of the transaction to be submitted to the acquirer 104 (e.g., to help ensure that subsequent transactions are properly processed, etc.). In addition, in some embodiments, the registration may include a registration for a single consumer. While, in other embodiments, the registration may include registrations, in bulk, for multiple consumers.

Once the consumer 114 is registered with the charity 110, and the donation engine 120 has received the consumer's registration, the donation engine 120 begins monitoring the consumer's payment account for transactions, at 404. In so doing, the donation engine 120 generally checks the payment account for transactions, based on a predefined interval (e.g., continuously, periodically (e.g., once a day, once every two days, once every week, etc.), etc.).

In connection with monitoring the consumer's payment account, the donation engine 120 identifies, at 406, all transactions made to the payment account by the consumer during the predefined interval. The identified transactions are then segregated as they are identified, for example, within the payment account, based on the predefined interval. Alternatively, the identified transactions may be extracted from the payment account, as they are identified, and stored in a data structure associated with the payment network 106 (e.g., within memory 204 of the payment network computing device 200, etc.), and segregated therein based on the predefined interval.

For each of the identified transactions, the donation engine 120 determines, at 408, if the transaction satisfies the various predefined donation conditions specified by the consumer 114 during registration (i.e., conditions that the transactions must satisfy in order to be used as a basis for a donation to the charity 110). When the transaction satisfies the consumer's donation conditions, the donation engine 120 appends the transaction to a donation ticket at 410, associated with the predefined interval for which the transaction was identified. However, when the transaction does not satisfy the consumer's donation conditions, the donation engine 120 excludes the transaction at 412. It should be appreciated that the consumer's donation conditions can be set and/or subsequently changed/modified by the consumer 114, as desired, at any time (e.g., via the website associated with the charity 110, via a website associated with the payment network 106 through which the consumer 114 can access his/her payment account, etc.).

Next, based on the donation conditions specified by the consumer 114, the donation engine 120 determines, at 413, a donation value for each of the transactions appended to the donation ticket during the predefined interval. The donation value is then included in the donation ticket, with the transaction from which it is determined. As an example, when the consumer 114 sets a condition during registration whereby $0.05 is donated per transaction, the donation engine 120 includes a $0.05 donation value in the donation ticket for each identified transaction during the predefined interval (that also satisfies any other conditions set by the consumer 114 during registration).

It should be appreciated that the donation engine 120 generates the donation values for the transactions based on the conditions set by the consumer 114 during registration. In some aspects, the conditions determine which transactions to include and which to exclude. In other aspects, the conditions determine donation values for the transactions. For example, a transaction by the consumer 114 to the consumer's payment account may be included or excluded by the donation engine 120, for use as a basis in determining a donation value for the transaction, based on the particular merchant involved in the transaction or the type of merchant involved in the transaction, taking into account MCC, etc. In another example, a donation value for a transaction may be limited based on an amount of the transaction (e.g., donation values may only be determined for transaction over $5.00, etc.), based on a total donation value already aggregated for the predefined interval (e.g., total donation values may be limited to $15.00 per predefined interval, etc.), based on a time/date of the transaction, and/or a total number of identified transactions for the predefined interval (e.g., donation values may only be determined for ten transactions per predefined interval, etc.), etc. In still other examples, other conditions set by the consumer 114 may relate to the consumer's transactions to the payment account, to the consumer 114, or to other aspect of the transactions.

In some embodiments, the donation values, as determined by the donation engine 120, may be assigned by the donation engine 120 to different charities based on one or more conditions (e.g., user preferences, etc.) specified by the consumer 114. For example, the consumer 114 may provide a condition at registration, or subsequently, that donation values for transactions involving merchants having a particular MCC (e.g., airlines, etc.) be assigned to a first charity, but that donation values for all other transactions be assigned to a second different charity. As another example, the consumer 114 may provide a condition at registration, or subsequently, that donation values for transactions involving a first payment account be assigned to a first charity, but that donation values for all other payment accounts be assigned to a second different charity. It should be appreciated that the charity 110 and/or the donation engine 120 may permit various different donation conditions, not only for different payment accounts, but also within a single payment account.

It should also be appreciated that, when the donation ticket is initially generated in the method 400 (e.g., when a first transaction in a predefined interval is appended to the donation ticket, etc.), the donation ticket is stored by donation engine 120 (e.g., in memory 204 of the computing device 200 associated with the donation engine 120, in memory 204 of the computing device 200 associated with the payment network 106, etc.). The donation ticket can then be updated, during the predefined interval, to include additional transactions as they are identified during the interval (and as they are determined to satisfy the consumer's various predefined conditions). In some embodiments, the donation tickets may be viewable, to the consumer 114, through the website associated with the charity 110. The charity's website may offer a dashboard, including tallies for transactions, donation markers, donation totals, etc. Further, for the registered consumer 114, qualifying activity (e.g., donations that satisfy the various predefined conditions, etc.) is posted at the end of the predefined interval through the consumers payment account at the payment network 106. As described herein, a feed to the charity may be provided as well. In other embodiments, the donation tickets may be viewable, to the consumer, through websites associated with the payment network 106 or by the issuer 108 (e.g., account websites through which the consumer 114 can view details of his/her payment account, where the account websites may directly include the donation tickets or where the account websites call the charity's website via an application program interface (API) to allow the consumer to view the donation tickets; etc.).

With continued reference to FIG. 4, at 414, the donation engine 120 determines if the predefined interval is expired. If the interval is not expired, the donation engine 120 continues operations 406-413 for the remaining duration of the predefined interval. However, once the predefined interval expires (or is complete), the donation engine 120 aggregates, at 416, the donation values included in the donation ticket for the given interval. More generally, the donation engine 120 sums the donation values for the charity 110, to be funded by the payment account for the predefined interval. In addition, the aggregated donation values are stored in memory 204 of the donation engine computing device 200 for a donation cycle (e.g., a cycle (e.g., one month, etc.) over which donation values are collected before being transmitted to the charity 110, as determined by the consumer 114, the charity 110, etc.; etc.). If other donation values are also pending in the memory 204, for the given donation cycle, all of the pending donation values will also be aggregated at 416, until the donation cycle expires (or is complete).

Next, the donation engine 120 determines at 418 if the aggregated donation values for the donation cycle exceed a donation limit (e.g., $20.00 per month, etc.), as provided by the consumer 114 during registration, or subsequently. When the aggregated donation values exceed the limit, the donation engine 120 reduces the donation values, at 420, to the specified donation limit (and thereby limits the donation to the charity 110 to the maximum amount specified by the consumer 114). In some embodiments, the consumer 114 may not set a donation limit condition, and thus the operation at 420 of limiting the donation may be omitted.

In some embodiments, the charity 110, the consumer 114, the donation engine 120, or another entity may specify a minimum transaction threshold (e.g., a minimum aggregated donation value, etc.) that must be satisfied before the donation value will be transmitted to the charity 110. When the aggregated donation value is less than the threshold, the donation engine 120 holds the donation value until the next donation cycle expires. If at that time, the combined aggregated donation values for the two donation cycles exceed the threshold, the donation engine 120 proceeds as below (otherwise, the combined aggregated donation values may be held until the next donation cycle expires, and so on).

In any case, after reducing the aggregated donation value at 420 or, conversely, if the aggregated donation value does not exceed the donation limit (or if no donation limit exists), the donation engine 120 submits a donation transaction to the acquirer 104 at 422, for payment of the aggregated donation value to the charity 110. The donation transaction is then handled substantially consistent to the payment transaction described above in the system 100 between the consumer 114 and the merchant 102.

Each donation transaction in the method 400 includes a merchant identifier (“ID”) associated with the charity 110, as if the charity is a merchant originating the transaction. In this manner, when the donation transactions are settled and cleared, the funds transferred from the issuer 108 of the appropriate consumer's payment account are provided to a payment account associated with the charity 110. Alternatively, if a donation transaction is declined, the acquirer 104 returns the transaction to the donation engine 120, and the donation engine 120 holds the transaction until the next donation cycle is expired. At that time, the donation engine 120 submits another transaction including the declined aggregated donation value plus any additional donation values for the next cycle (if not exceeding the donation limit, for example).

As the donation transactions are completed in the method 400, and prior, the donation engine 120 may store donation values, donation transactions, and other information related to the above, in memory 204 of computing device 200. The information may be accessible to the charity 110, or through the charity's website (or application) to permit the charity 110 to view and/or disseminate certain information about donations received, or to permit the consumer 114 to review transactions and donation details for the charity 110 and/or the consumer's associated payment account. In various embodiments, a dashboard may be viewable by the charity 110 (e.g., hosted by the charity 110 or by the donation engine 120, etc.), which provides summaries of, for example, donations per time period, total registered consumers/donors, total donation values, total donation transactions, average donations per consumer, etc. Similarly, in various embodiments, a dashboard may be available to the consumer 114, through a charity's website, whereby the consumer 114 is able to view, for example, depictions of historical donations, transactions, goals and/or predicted donations, and/or reports related to declined transactions, donations, transactions, goals, etc.

It should be appreciated that a donation transaction may be submitted by the donation engine 120 alone, or as part of a batch file with other donation transactions to be processed via the acquirer 104. For example, where multiple consumers 114 all select to associate their payment accounts with the charity 110, multiple donation transactions for payment to the charity 110 may be submitted each donation cycle. As such, here, the donation engine 120 may batch the donation transactions together and submit them together (at one time) to the acquirer 104. In the illustrated embodiment, a single donation transaction is made to the charity 110, per payment account and per donation cycle (and only if the various predefined conditions for the donation transaction are satisfied). However, it is should be appreciated that in other embodiments, multiple donation transactions may be made to the charity 110 and/or to other charities, per payment account and/or per donation cycle. It should also be appreciated that in other embodiments, multiple donation transactions may be made to the charity 110, per payment account and/or per donation cycle.

It should further be appreciated that, while the donation engine 120 is described in the method 400 with reference to one payment account, the donation engine 120 may perform the method 400 with respect to multiple payment accounts, multiple consumers and/or multiple charities.

As previously described, in some embodiments, registration of the consumers 114 may be done individually, such that each registration includes a registration for a single individual consumer. While, in other embodiments, the registration of the consumers 114 may be done in bulk or in batch, such that each registration includes registrations for multiple consumers (with little or minimal effort required by the consumers).

For example, in connection with an individual registration, the consumers 114 may be directed by the issuer 108 to a donation platform (e.g., the website previously discussed, etc.), for the charity 110, via a URL. The URL can, for example, be exposed to the consumers 114 via the issuer's home banking site, etc., and the proposition of making donations to the charity 110 can be introduced to the consumers 114 by the issuer 108 as desired (e.g., via marketing on the banking site or through mailings, via advertising on the banking site or through mailings, etc.). At the donation platform, the consumers 114 can register on an individual basis, such as by selecting a registration button at the donation platform and then entering various details relating to their individual registration (e.g., individual identification data such as name, address, etc.; user name and password; answers to security questions; donation parameters; etc.). Once registered, the consumers 114 can then access (e.g., login to, etc.) a personal dashboard at the donation platform to manage their donations (e.g., monitor donations, make changes to the donation parameters they set at registration or subsequent thereto, etc.).

As another example, and again in connection with the individual registration, the consumers 114 may be exposed to the proposition of making donations to the charity 110 when they are issued payment devices by the issuer 108. Here, for example, the particular payment devices issued to the consumers 114 (or available for selection by the consumers 114) may each include a unique selling point or feature in that certain use of the payment devices triggers donations to the charity 110. In this implementation, the consumers 114 register, again at their own initiative, after receiving the payment devices, and then set their donation preferences.

As a further example, in connection with a batch registration of the consumers 114, the issuer 108 may obtain preliminary registration data from each of the consumers 114 who express interest in making donations to the charity 110, when the consumers 114 are issued payment devices (e.g., as part of the issuance process, etc.). The issuer 108 then transmits (e.g., via the network 112, etc.) the collected registration data for the consumers 114 to the payment network 106 for formal registration. Thus, in this implementation, at the time the payment devices are issued to the consumers 114, the consumers 114 signal their intent and willingness, to the issuer 108, to donate to the charity 110, and the issuer 108 then takes care of collecting the relevant default data to bring about registration of the consumers 114 (without the consumers having to access a website to actually register). Once registered, the consumers 114 can then access (e.g., login to, etc.) a personal dashboard at the donation platform associated with the charity 110 to manage their donations (e.g., monitor donations, make changes to the donation parameters they set at registration or subsequent thereto, etc.).

It should be appreciated that the functions described herein, in some embodiments, may be described in computer executable instructions stored on a computer readable media, and executable by one or more processors. The computer readable media is a non-transitory computer readable media. By way of example, and not limitation, such computer readable media can include RAM, ROM, EEPROM, CD-ROM or other optical disk storage, magnetic disk storage or other magnetic storage device, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of the following steps: (a) identifying at least one transaction associated with a payment account; (b) generating, by a computing device, a donation value to the payment account based on the at least on transaction; (c) aggregating, by the computing device, the donation value for the at least one transaction; and (d) submitting a donation transaction, to an acquirer associated with the charity, for payment to the charity of an amount based on at least the aggregated donation values.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail. In addition, advantages and improvements that may be achieved with one or more exemplary embodiments disclosed herein may provide all or none of the above mentioned advantages and improvements and still fall within the scope of the present disclosure.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method for use in generating donations to a charity through transactions to a payment account, the method comprising:
identifying at least one transaction associated with a payment account;
generating, by a computing device, a donation value to the payment account based on the at least one transaction;
aggregating, by the computing device, the donation value for the at least one transaction; and
submitting a donation transaction, to an acquirer associated with the charity, for payment to the charity of an amount based on at least the aggregated donation value.

2. The method of claim 1, wherein generating the donation value is further based on at least one condition associated with the at least one transaction.

3. The method of claim 2, wherein the at least one condition includes at least one of an amount of the at least on transaction and a merchant category code of a merchant involved in the at least one transaction.

4. The method of claim 1, wherein the at least one transaction includes multiple transactions within a predefined interval, and wherein aggregating the donation value includes aggregating the donation value for each of the multiple transactions, after the predefined interval.

5. The method of claim 1, further comprising receiving a registration for the payment account, the registration including at least one user preference; and
wherein generating the donation value is further based on the at least one user preference.

6. The method of claim 1, wherein submitting the donation transaction for payment includes submitting a batch file to the acquirer, the batch file including the donation transaction along with multiple other donation transactions for payment to the charity, each of the multiple other donation transactions being for payment to the charity from different payment accounts.

7. The method of claim 1, further comprising limiting the donation transaction for payment to the charity to a donation limit, when an amount indicated by the aggregated donation value exceeds the donation limit.

8. The method of claim 1, wherein the payment account is associated with a condition; and
wherein submitting the donation transaction includes:
submitting the donation transaction for payment to the charity when the condition is satisfied; and
submitting the donation transaction for payment to a different charity when the condition is not satisfied.

9. A system for use in collecting donations to a charity merchant, the system comprising:
a memory including a data structure of multiple payment accounts, wherein each of the payment accounts is associated with a consumer, and wherein each of the payment accounts is linked to at least one charity; and
at least one processor coupled to the memory and configured to:
identify transactions associated with the payment accounts;
for each of the identified transactions, generate a donation value to the payment account to which the identified transaction is directed;
aggregate the donation values, per payment account, for each of the payment accounts;
generate a batch transaction file, for each charity to which the donation values are designated; and
submit the batch transaction file to an acquirer associated with the appropriate charity.

10. The system of claim 9, wherein the at least one processor is configured to generate the batch transaction file based on at least one parameter of the acquirer to which the batch transaction file is to be submitted.

11. The system of claim 9, wherein the donation value generated to at least one of the payment accounts is based on at least one condition associated with the corresponding transaction.

12. The system of claim 11, wherein the at least one condition includes a minimum donation transaction threshold; and
wherein the at least one processor is configured to hold a donation transaction until a next donation cycle, when the minimum donation transaction threshold is not satisfied.

13. The system of claim 11, wherein the at least one condition includes one of an amount of a transaction, a minimum number of transactions per donation value, and a merchant category code of a merchant involved in a transaction.

14. The system of claim 11, wherein the at least one condition includes a donation limit for time interval; and
wherein the at least one processor is configured to modify the transaction associated with one of the donation values to satisfy the donation limit, when said transaction exceeds the donation limit.

15. The system of claim 9, wherein the at least one processor is configured to aggregate the donation values, per payment account, periodically, during a predefined interval.

16. A non-transitory computer readable media including executable instructions which, when executed by at least one processor, cause the at least one processor to:
identify, from a payment network, transactions associated with a payment account registered to make donation transactions to a charity based on at least one condition;
generate a donation value for each of the identified transactions;
aggregate the generated donation values; and
submit a donation transaction, to an acquirer associated with the charity, for payment to the charity of an amount based on at least the aggregated donation values.

17. The non-transitory computer readable media of claim 16, wherein the at least one condition includes at least one of a transaction amount and a merchant category code of a merchant involved in the transactions.

18. The non-transitory computer readable media of claim 16, wherein the identified transactions include transactions within a predefined interval.

19. The non-transitory computer readable media of claim 16, wherein the donation transaction submitted to the acquirer is part of a batch file of multiple other donation transactions submitted to the acquirer for payment to the charity, each of the multiple other donation transactions being for payment to the charity from different payment accounts registered to make donation transactions to the charity.

20. The non-transitory computer readable media of claim 16, wherein the at least one processor is further configured to limit the donation transaction for payment to the charity to a donation limit, when an amount indicated by the aggregated donation values exceeds the donation limit.
